(19) United States
(12) Patent Application Publication
(10) Pub. No.: US 2019/0075863 A1
(43) Pub. Date: Mar. 14, 2019

(54) FUNCTIONAL MASK

(71) Applicant: Kwang Seok KO, Seoul (KR)

(72) Inventor: Kwang Seok KO, Seoul (KR)

(21) Appl. No.: 15/876,585

(22) Filed: Jan. 22, 2018

(30) Foreign Application Priority Data
Sep. 8, 2017 (KR) 20-2017-0004764

(51) Int. Cl. A41D 13/11; A62B 23/02; A62B 18/02

(52) U.S. Cl. CPC A41D 13/1138; A62B 18/025; A62B 23/025

(57) ABSTRACT

The present utility model relates to a functional mask which maintains a certain shape to improve a wearing sensation, and prevents fogging of eyeglasses and dew condensation inside the mask, particularly without pressing the nose. A functional mask according to an embodiment of the present utility model may include a mask body in which a central part corresponding to positions of an outer nose and lips protrudes and an overall shape is convex; a plurality of ventilation holes formed in the central part to facilitate the entry and exit of air; and a left outer nose support member and a right outer nose support member which are spaced apart from each other on both sides of a nose support provided at an upper position of the mask body abutting with a nose.

### CROSS-REFERENCE TO RELATED APPLICATION

This application claims priority from Korean Utility Model Application No. 20-2017-0004764 filed on Sep. 8, 2017 in the Korean Intellectual Property Office, the contents of which in its entirety are herein incorporated by reference.

### BACKGROUND

### 1. Field of the Invention

The present utility model relates to a functional mask, and more particularly, to a functional mask in which a certain shape is maintained to improve a wearing sensation, and in particular, a shape can be maintained such that the mask can be worn on a clothing accessory such as a neck warmer, and moreover, it is possible to prevent fogging of eyeglasses and dew condensation phenomenon inside the mask.

### 2. Description of the Related Art

A general mask for prevent sucking or scattering of foreign matter is made of fibers or cotton and is mainly used for keeping warm. However, the shape of the mask for keeping warm made of fiber or cotton may be deformed by breathing faster when exercising. Especially when the user breathes hard, since the mask may be dragged into the nose and the nose may be blocked with the mask, the user may feel discomfort by the mask.

As a related art relating to a mask, there is Japanese Registered Patent No. 4372638 entitled a three-dimensional mask. The above related art discloses a three-dimensional mask in which a gap is not generated between a peripheral portion of the mask and the skin, the touch is improved to endure the use for a long time, the mask body does not feel a sense of pressure shrink and does not shrink even when repeatedly washed, a wrinkle is hard to occur.

Korean Registered Patent No. 10-1635392 relating to a mask discloses a mask that maintains a certain shape.

However, the related art of Japanese Registered Patent No. 4372638 merely discloses the effect of preventing the mask from being distorted from the face due to the movement of the lip, but does not disclose a configuration in which a three-dimensional shape itself of the mask body is maintained even when breathing faster. Also, related art of Korean Registered Patent No. 10-1635392 discloses that the shape can be maintained, but there is a limit to achieving the function of preventing the mask from being distorted from the face at the time of rapid breathing only by the material itself. Further, the material of the mask disclosed in Korean Registered Patent No. 10-1635392 may cause inconvenience for use, since dew condensation phenomenon occurs inside the mask due to the characteristics of the material.

The above-mentioned related arts do not disclose the technique of preventing eyeglass fogging and dew condensation inside the mask caused by expiration generated at the time of rapid breathing.

### SUMMARY

The present utility model has been devised to solve the above-mentioned problems, and an object of the present utility model is to provide a functional mask in which a three-dimensional shape itself of the mask body is maintained the even when breathing hard, and fogging of eyeglasses and dew condensation inside the mask are prevented.

Further, another object of the present utility model is to provide a functional mask that can be worn in conjunction with sportswear or outdoor clothing worn during outdoor activities as well as clothing accessory such as neck warmers.

The objects of the present utility model are not limited to those mentioned above but another object which is not mentioned may be clearly understood from the description below to the ordinary technician in the technical field to which the present utility model belongs.

In order to achieve the aforementioned objects, a functional mask capable of maintaining a shape according to an embodiment of the present utility model may include a mask body in which a central part corresponding to positions of an outer nose and lips protrudes and an overall shape is convex; a plurality of ventilation holes formed in the central part to facilitate the entry and exit of air; and a left outer nose support member and a right outer nose support member which are spaced apart from each other on both sides of a nose support provided at an upper position of the mask body abutting with a nose.

The left outer nose support member and the right outer nose support member of the functional mask according to the embodiment of the present utility model may protrude from the nose support to the portion with which both cheeks abut to prevent a gap from being split between the nose and both cheeks when wearing the mask, while forming a separated space between an inner surface of the mask and the face in the state of wearing the mask.

The mask body according to an embodiment of the present utility model may be made of a material capable of maintaining a convex shape so that the separated space is maintained.

The left outer nose support member and the right outer nose support member according to an embodiment of the present utility model may also be formed to protrude at a lower position of the mask body.

The mask body according to an embodiment of the present utility model may be used in combination with clothing or clothing accessory, a fine dust filter for blocking harmful substances from outside air may be included between the mask body and the clothing or between the mask body and the clothing accessory, and the fine dust filter may be attached and detached.

A patch coated with a fragrance extract may be attached to the inner surface or the outer surface of the mask body according to an embodiment of the present utility model.

The material of the mask body according to an embodiment of the present utility model may be rubber, silicon, polypropylene or polyurethane foam.

A convex-concave air discharge embossment may be formed in the mask according to an embodiment of the present utility model to provide a passage for discharging expiration in the lower part of the mask body.

The air discharge embossment according to an embodiment of the present utility model may be formed to extend in a direction perpendicular to a lower end of the mask body from a predetermined position of the lower portion of the mask body.

According to the functional mask capable of maintaining the shape according to the embodiment of the present utility model described above, even when breathing quickly with exercising, since the mask is not dragged into the nose side, a user does not feel inconvenience, and the wearing sensation can be improved.

Further, when the user wears a neck warmer or sportswear, by combining the functional mask according to the embodiment of the present utility model with a neck warmer or sportswear, a conventional problem in which a conventional neck warmer or sportswear is dragged into the nose when breathing hard to make the breathe uncomfortable can be improved.

Furthermore, when the user couples the functional mask according to an embodiment of the present utility model to a neck warmer or sportswear, it is possible to further combine a fine dust filter or a fragrance patch to block fine dust or to provide a fragrance suitable for preference of the user.

Also, the functional mask according to the embodiment of the present utility model can not only prevent the mask from being distorted from the face at the time of heavy exercise by an outer nose support member formed on the mask body, but also may prevent a phenomenon in which the air from being discharged to an upper part of the nose and the glasses steam up when breathing hard.

Furthermore, the functional mask according to an embodiment of the present utility model not only can eliminate the dew condensation phenomenon occurring inside the mask due to the air discharge embossment formed on the lower end of the mask body, but also prevent deformation of the mask shape, increase the strength of the mask body and improve the durability of maintaining the shape of the mask for a long period of time.

### BRIEF DESCRIPTION OF THE DRAWINGS

FIG. 1A is a perspective view of a functional mask according to one embodiment of the present utility model;

FIG. 1B is a side view of a functional mask according to one embodiment of the present utility model;

FIG. 2 is a rear view of a functional mask according to another embodiment of the present utility model;

FIG. 3 also illustrates the use of a functional mask according to still another embodiment of the present utility model;

FIG. 4 is an exploded view of a functional mask according to still another embodiment of the present utility model;

FIG. 5 is a perspective view of a functional mask formed with embossment according to still another embodiment of the present utility model; and

FIG. 6 is a rear view of a functional mask formed with embossment according to still another embodiment of the present utility model.

### DETAILED DESCRIPTION OF THE EMBODIMENTS

Hereafter, preferred embodiments of the present utility model will be described in detail referring to the accompanied drawings. Advantages and features of the present invention and methods of achieving the same will become apparent with reference to the embodiments described in detail below in conjunction with the accompanying drawings. However, the present utility model is not limited to the embodiments disclosed below, but may be provided in various different forms. The present embodiments are merely provided to make the disclosure of the present utility complete and to fully inform the category of the invention to a person having ordinary knowledge in the technical field to which the present invention pertains, and the present utility is only defined by the scope of the claims. The same reference numerals refer to the same constituent elements throughout the specification.

Unless otherwise defined, all terms (including technical and scientific terms) used in this specification may be used in the meaning that can be understood in common by those having ordinary skill in the technical field to which the present utility model belongs. Also, commonly used predefined terms are not interpreted ideally or unduly unless expressly defined otherwise.

Further, as used herein, the singular form also includes the plural forms unless specifically stated in a phrase. The terms “comprises” and/or “comprising” used in the specification do not exclude the presence or addition of one or more other constituent elements, steps, operations and/or elements, in addition to the referenced constituent elements, step, operation and/or element.

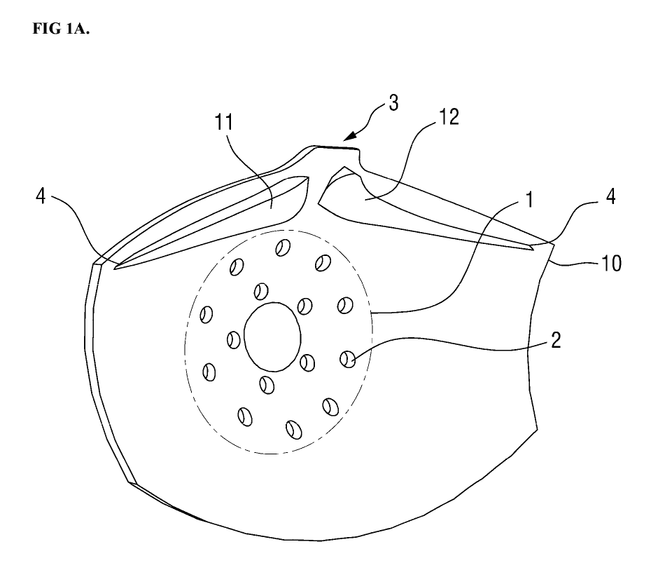

FIG. 1a is a perspective view and FIG. 1b is a side view of a functional mask according to an embodiment of the present utility model.

Referring to FIG. 1a and FIG. 1b, the functional mask according to an embodiment of the present utility model has a central part 1 protruding so as to have a hemispherical convex shape as a whole so that an empty space can be formed between the face and the mask at the time of wearing.

A functional mask according to an embodiment of the present utility model may have a plurality of ventilation holes formed at a central part 1 corresponding to positions of an outer nose and a lip so as to prevent a shape of a mask body 10 from being deformed by the pressure of the air at the time of the user's inspiration and expiration.

By providing the ventilation hole 2 in the central part 1 of the mask body 10 according to an embodiment of the present utility model, an area in which air enters and exits the mask body 10 at the time of the user's inspiration and expiration is enlarged, which makes it is possible to prevent the shape of the mask from being deformed by the pressure of the air and to make the user breathe easily.

Further, as illustrated in FIG. 1, the functional mask according to an embodiment of the present utility model is provided with a nose support 3 at the upper position of the mask body 10 to which nose is brought into contact, a left outer nose support member 11 and a right outer nose support member 12 may be spaced apart from each other on both sides of the nose support 3.

More specifically, the outer nose support member according to an embodiment of the present utility model may be protrude so that it is possible to fill a gap that separates when wearing a mask from the nose support 3 to the portions 4 of the mask body 10 with which both cheeks abut. Meanwhile, the outer nose support member may be made of the same material as the mask body 10.

Alternatively, after putting a sponge over the mask body 10 and covering the fabric on the mask body 10, by applying heat or compressive force to the position of the outer nose support member, the outer nose support member can be molded to protrude.

The left outer nose support member 11 and the right outer nose support member 12 may serve to support the mask body 10 so that the separated space 5 formed between the inner surface of the mask and the face can be maintained.

Further, the left outer nose support member 11 and the right outer nose support member 12 can also serve to hold a shape to prevent the shape of the mask body 10 from being deformed by overbreathing at the time of wearing the mask.

Therefore, when the functional mask according to one embodiment of the present utility model is worn, a separated space 5 may be formed between the mask body 10 and the outer nose 50.

On the other hand, since the outer nose support member according to the embodiment of the present utility model protrudes considerably long from the nose support 3 to the portions 4 with which both cheeks abut, it is possible to completely cover the gap in which the mask may separate between the nose and both cheeks.

Therefore, when breathing quickly, fogging of the glasses can be prevented by preventing the divergence from leaking from the separated gaps around the nose.

In the conventional masks, hard solid materials such as metal are coupled to the nose part in order to solve the problem such as fogging of the eyeglasses. However, in such a case, there was a problem of inconvenient due to application of pressure to the nose part.

However, the functional mask according to an embodiment of the present utility model can provide comfortable wearing sensation for the user, by providing a material such as the mask body 10 or an outer nose support member in the form of a sponge.

Also, since the outer nose support member is formed long from the position of the nose to the position of both cheeks and the load of the outer nose support member is dispersed, the user does not feel inconvenience due to the outer nose support member.

According to an embodiment of the present utility model, the main body of the functional mask can be made of a material capable of maintaining a convex shape so that the separated space 5 is maintained. More specifically, a mask according to an embodiment of the present utility model can be manufactured by a shape maintenance material that can be restored to its original shape, even if a certain level of external force or external pressure acts on the mask and the shape deforms, when the external force or the external pressure is removed.

The shape maintenance material according to an embodiment of the present utility model can be made of an elastic material, but can be, for example, rubber, silicon, polypropylene or polyurethane foam, but is not necessarily limited thereto.

On the other hand, the shape maintenance material can be made using a fiber material capable of maintaining its shape, and may include synthetic resin or synthetic fiber.

Further, the mask body 10 according to an embodiment of the present utility model can be made of a breathable material so that air can enter and exit, and only the central part 1 can be made of a breathable material if necessary.

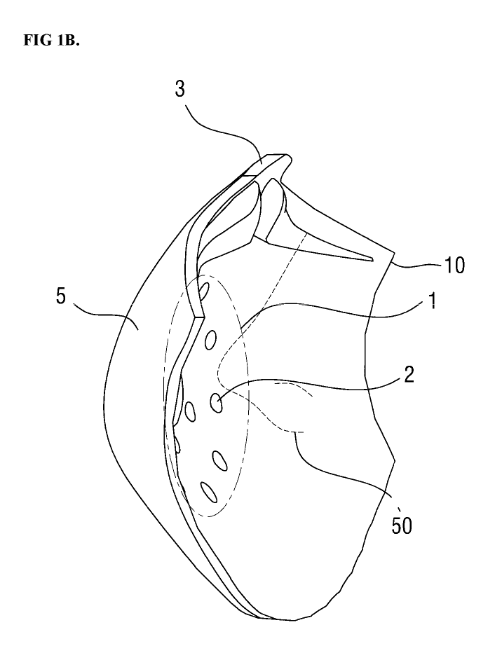

FIG. 2 is a rear view of a functional mask according to another embodiment of the present utility model.

The left outer nose support member 11 and the right outer nose support member 12 according to an embodiment of the present utility model can also be located to protrude from the lower position of the mask body. Therefore, the functional mask according to another embodiment of the present utility model can be used without distinction between upper and lower parts.

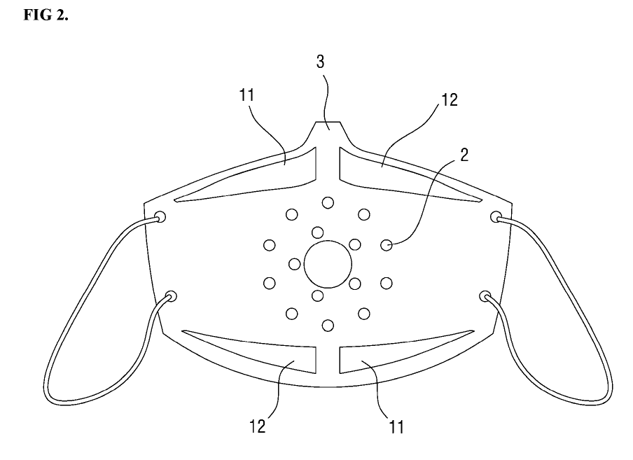

FIG. 3 illustrates the use of a functional mask according to still another embodiment of the present utility model.

The functional mask according to an embodiment of the present utility model can be used by being combined with clothing accessory such as neck warmers and shawls as illustrated in FIG. 3.

The functional mask according to an embodiment of the present utility model can be used in combination with sportswear or outdoor clothing, in addition to the clothing accessory 20.

Specifically, the clothing accessory 20 or the outer skin of the garment can be combined with the outer surface of the mask body 10 in the form of being put over the outer surface.

Therefore, since the functional mask according to an embodiment of the present utility model can be used in combination with a clothing accessory 20 or clothing, the functional mask protects a user' body from outside environment such as ultraviolet rays, snow, and wind during outdoor activities, and can prevent the nose from being blocked by the cloth even if the user breathes hard.

On the other hand, the functional mask according to an embodiment of the present utility model is not limited by the wearing method or use.

As illustrated in FIG. 2, the functional mask according to another embodiment of the present utility model can also be used alone as a mask. Referring to FIG. 2, it is possible to use the mask alone, by forming holes on both side surfaces of the mask body 10 and by attaching a strap connectable to the ears.

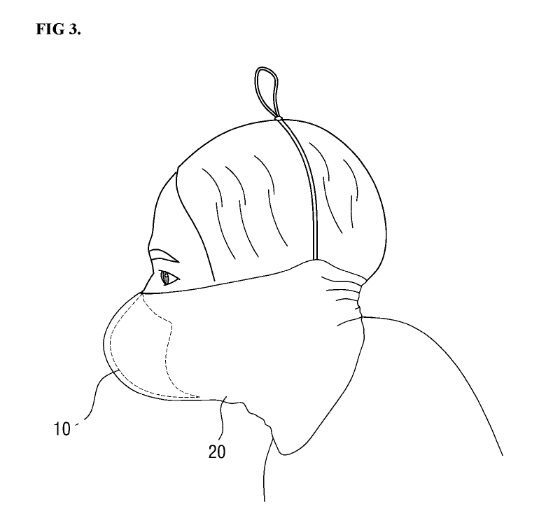

FIG. 4 is an exploded view of a functional mask according to still another embodiment of the present utility model.

Referring to FIG. 4, in order to further reinforce the dust-proof use for shielding harmful substances from the outside air, a functional mask according to another embodiment of the present utility model may further include a fine dust filter 30 between the mask body 10 and a clothing accessory 20 or clothing.

On the other hand, the functional mask according to another embodiment of the present utility model may have a structure capable of attaching and detaching the fine dust filter 30.

According to still another embodiment of the present utility model, a patch 40 coated with fragrance extract may be used in place of the fine dust filter. For example, when a patch according to an embodiment of the present utility model is coated with a phytoncide extract, the patch has refreshing phytoncide, and by sucking the phytoncide component, it is possible to obtain effects of stress reduction, cardiopulmonary function strengthened and sterilizing action.

The fine dust filter 30 or the patch 40 according to the embodiment of the present utility model is manufactured in the form of a sheet, and can be put over the mask.

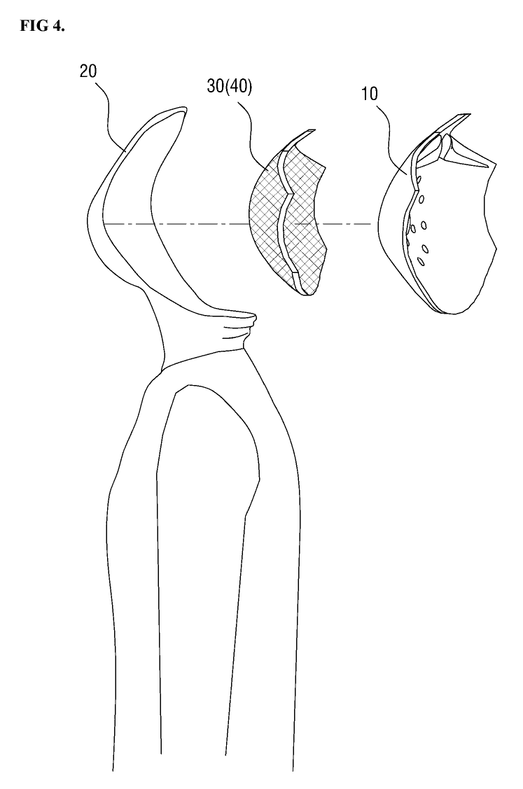

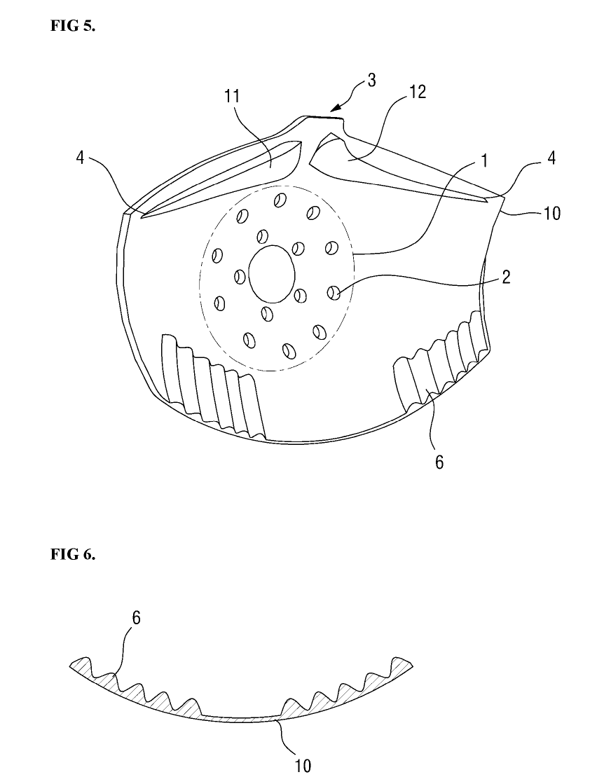

FIG. 5 is a perspective view of a functional mask in which embossment is formed according to another embodiment of the present utility model, and FIG. 6 is a rear view thereof.

In the functional mask according to the embodiment of the present utility model, the convex-concave air discharge embossments 6 can be formed so as to provide a passage for discharging expiration in the lower part of the mask body 10.

That is, on the lower part of the mask body 10, the embossments 6 having irregularities on the surface in the vertical direction can be formed from a predetermined position (for example, below the central part) to the lower end of the mask body.

The air discharge embossments 6 according to the embodiment of the present utility model can help to eliminate dew condensation phenomena occurring inside the mask by providing a passage for discharge of expiration.

Furthermore, according to an embodiment of the present utility model, the functional mask having the unevenness on the lower surface of the mask also has advantages that not only prevents deformation of the mask shape but also enhances the strength of the mask body to enhance the durability of maintaining the shape of the mask for a long period of time.

It will be understood by those having ordinary skill in the technical field related to the present embodiment that the present utility model can be provided in a modified form without departing from the above-mentioned essential characteristics. Therefore, the disclosed method should be considered from a descriptive viewpoint, rather than a limited viewpoint. The scope of the present utility model is set forth in the claims rather than the above description, and all differences within the scope equivalent thereto should be interpreted as being included in the present utility model.

### EXPLANATION OF SIGN

1: Central part
2: Ventilation hole
3: Nose support
4: Part with which both cheeks but
5: Separated space
6: Air discharge embossment
10: Mask body
11: Left outer nose support member
12: Right outer nose support member
20: Clothing accessory
30: Fine dust filter
40: Patch

What is claimed is:

1. A functional mask comprising:
a mask body in which a central part corresponding to positions of an outer nose and lips protrudes and an overall shape is convex;
a plurality of ventilation holes formed in the central part to facilitate the entry and exit of air; and
a left outer nose support member and a right outer nose support member which are spaced apart from each other on both sides of a nose support provided at an upper position of the mask body abutting with a nose,
wherein the left outer nose support member and the right outer nose support member protrude from the nose support to the portion with which both cheeks abut to prevent a gap from being split between the nose and both cheeks when wearing the mask, while forming a separated space between an inner surface of the mask and the face in the state of wearing the mask, and
the mask body is made of a material capable of maintaining a convex shape so that the separated space is maintained

2. The functional mask of claim 1, wherein the left outer nose support member and the right outer nose support member are also formed to protrude at a lower position of the mask body and are usable regardless of the upper and lower sides.

3. The functional mask of claim 1, wherein the mask body is used in combination with clothing or clothing accessory,
a fine dust filter for blocking harmful substances from outside air is included between the mask body and the clothing or between the mask body and the clothing accessory, and
the fine dust filter is attached and detached.

4. The functional mask of claim 1, wherein a patch coated with a fragrance extract is attached to the inner surface or the outer surface of the mask body.

5. The functional mask of claim 1, wherein the material is rubber, silicon, polypropylene or polyurethane foam.

6. The functional mask of claim 1, wherein a convex-concave air discharge embossment is formed to provide a passage for discharging expiration in the lower part of the mask body.

7. The functional mask of claim 6, wherein the air discharge embossment is formed to extend in a direction perpendicular to a lower end of the mask body from a predetermined position of the lower portion of the mask body.
